(19) United States
(12) Patent Application Publication
(10) Pub. No.: US 2004/0075270 A1
(43) Pub. Date: Apr. 22, 2004

(54) Annotation apparatus for written material

(76) Inventor: Lee Passarella, Delray Beach, FL (US)

Correspondence Address: Gregory A. Nelson, Akerman Senterfitt & Eidson, P.A., 222 Lakeview Avenue, Fourth Floor, P.O. Box 3188, West Palm Beach, FL, 33402-3188, US

(21) Appl. No.: 10/272,744

(22) Filed: Oct. 17, 2002

(51) Int. Cl. B42D 3/18

(52) U.S. Cl. 281/51

(57) ABSTRACT

An annotation apparatus for written material has an elongated support. At least one annotation device is secured to the support. The annotation device can include writing implements, place markers, and removable notes. The elongated support can be weighted. A method for annotating at least one sheet of written material is also disclosed.

### FIELD OF THE INVENTION

This invention relates to annotation devices for books, periodicals, newspapers, stationery, and the like.

### BACKGROUND OF THE INVENTION

The practice of reading, conducting scholarly research, fact gathering, and generally working with written material frequently involves annotating the written material by highlighting, noting, or marking pertinent portions and passages. The process can require a variety of writing, marking, and note-taking implements. Assembling these implements and keeping pages and sheets of written material in place during the process can be difficult. There is a need for apparatus that will facilitate the annotation process.

### SUMMARY OF THE INVENTION

A book annotation apparatus comprises an elongated support and at least one book annotation device secured to said support. At least one weight is preferably fixed to the support. At least two weights can be secured to opposing ends of the elongated support.

The support preferably has at least one side straight edge portion. The support can be substantially rectangular. The elongated support can have a substantially flat bottom portion. The support can be flexible. In one aspect, the support is made of leather.

The annotation device can be a writing implement. The support comprises a structure for securing a writing implement. The writing implement can be a pen, pencil, highlighter, or any other suitable writing or marking implement. The structure for securing the writing implement can be a loop for encircling and securing the writing implement.

The annotation device can be removable place markers. The annotation device can also include stationery. The stationery can be removable adhesive notes. The annotation device can be other suitable devices such as magnifiers, letter openers and the like.

A method for annotating written material includes the steps of providing an elongated support with at least one annotation device secured thereto. The elongated support is placed on at least one sheet of written material so as to hold the sheet in place. The annotation device is used to annotate the written material.

### DESCRIPTION OF THE DRAWINGS

There are shown in the drawings embodiments which are presently preferred, it being understood, however, that the invention is not limited to the precise arrangements and instrumentalities, wherein:

FIG. 1 is a top plan view of a book annotation apparatus according to the invention.

FIG. 2 is a bottom view.

FIG. 3 is a front elevation.

FIG. 4 is a rear elevation.

FIG. 5 is a right side elevation.

FIG. 6 is a left side elevation.

FIG. 7 is a perspective view.

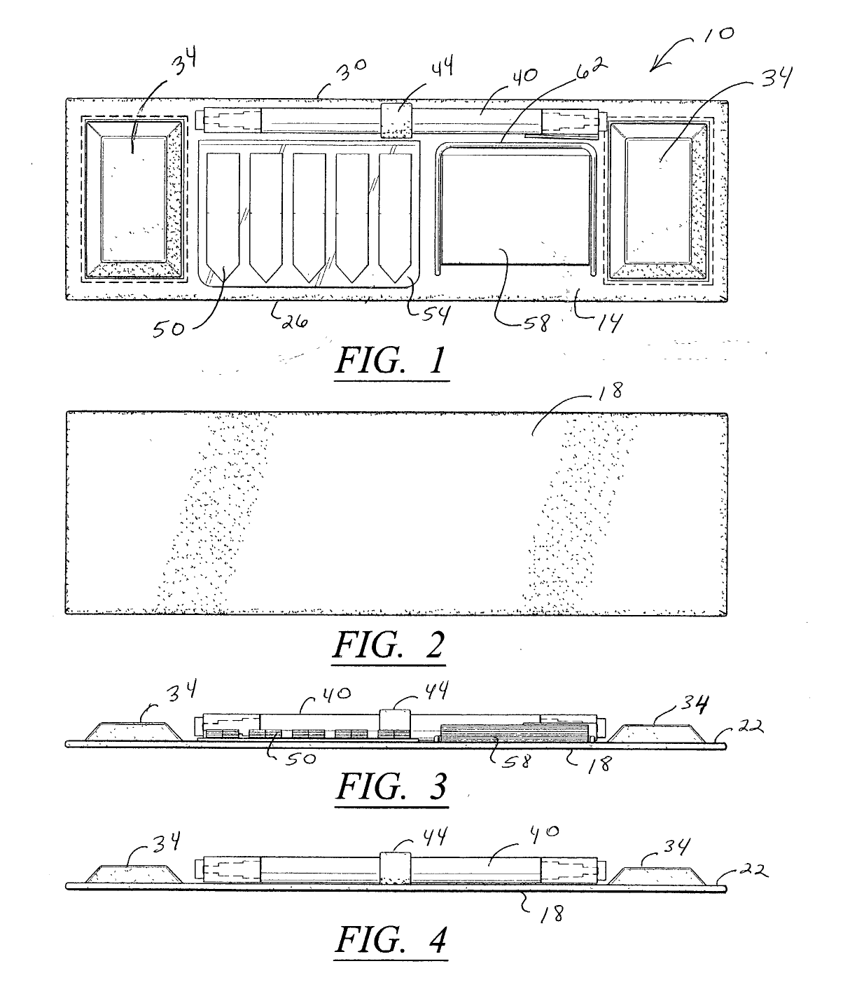

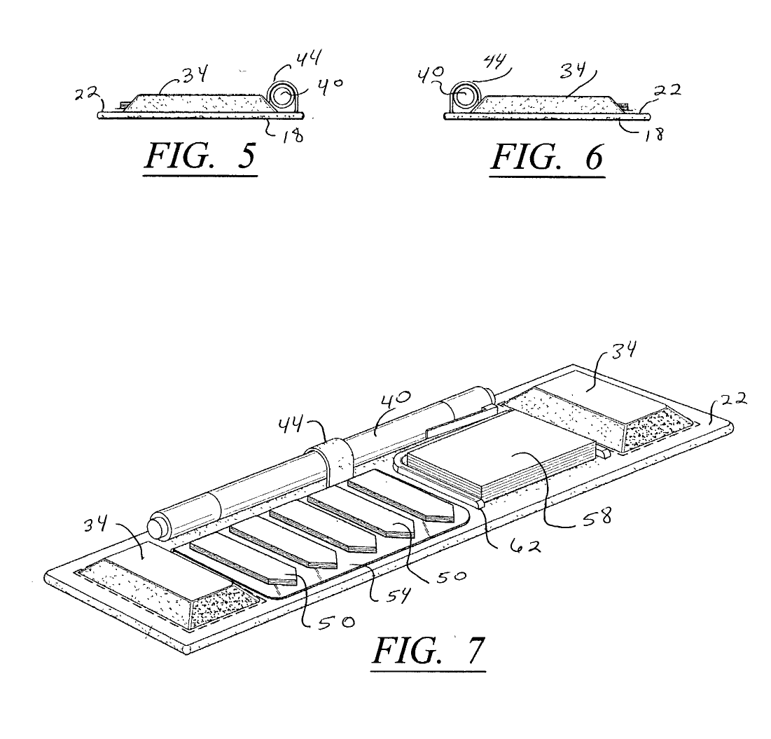

### DESCRIPTION OF THE PREFERRED EMBODIMENTS

A book annotation apparatus 10 according to the invention includes an elongated support 14. The support 14 can have a variety of different shapes and sizes. In the embodiments shown, the support 14 is substantially rectangular and has a flat bottom portion 18. The flat bottom portion 18 permits the support 14 to rest evenly on a sheet of written material, book, or periodical. The support 14 has a top surface 22 to which at least one book annotation device can be secured. The support 14 can have at least one straight edge portion, such as along the front side edge 26 or rear side edge 30. The straight edge portion allows the support 14 to be used as a place holder, indicating a line of written material which is being reviewed.

The support 14 can have sufficient weight to be useful for holding at least one sheet of written material in place, or for holding a book open. Weight can be added to the support 14. The weight can be provided in a variety of locations on or within the support 14. As shown in the figures, weights 34 can be provided at opposing ends of the elongated support 14. The weights 34 can be of any suitable dense material, such as metal. The weights 34 can be provided in pockets formed in the support 14 by appropriate stitching or sewing.

The support 14 can be substantially flexible. Flexibility permits the support 14 to conform to contours of an opened book or periodical, and also to lie flat against flat sheets of written material. The support 14 can be made of any suitable material. It is preferable that the material be durable yet without sharp rigid edges such as might tear sheets of written material. It is also desirable that the material be aesthetically pleasing. Leather and plastics are currently preferred materials.

The annotation devices can be selected from many suitable annotation devices. A writing implement 40 such as a highlighter, pen, or pencil can be provided. The writing implement 40 can be secured to the support 14 by suitable structure. In one embodiment, a loop 44 is provided into which the writing implement 40 is placed for securing the writing implement 40 to the support 14. Other annotation devices can also be provided or can be alternatively provided. Place markers 50 are known annotation devices which are commonly made from thin plastic films and include a mild adhesive for securing the place marker to a sheet of written material so as to indicate a particular portion or passage to which the user wishes to refer in the future. Such place markers 50 can be provided on a base 54 that is secured to the support 14 by suitable means such as positioning a flap provided with the base 54 in a pocket provided on the support 14. Stationery can also be provided and secured to the support 14 by suitable structure. The stationery can, in one aspect, be notes 58 with a weak adhesive for securing the notes to each other for storage, and to the written material or other object when in use. The notes 58 can be secured to the support 14 by suitable structure such as a pocket, or can be adhered to an area 62 using the weak adhesive of the notes. Other suitable annotation devices can include magnifiers, letter openers and other annotation instruments.

In use, the support 14 is placed on the written material which is to be annotated. The written material can be any suitable sheet material, such as an open book, printed pages, newspaper, periodicals, pamphlets, brochures, posters, and the like. The weight of the support 14 holds the written material in place. In the case where the written material is a book, the support 14 is laid across the pages of the opened book and will hold the book open to the appropriate pages in the manner of a book weight or book mark. The annotation devices can then be used to annotate the written material in any desired fashion.

The support 14 can be of any suitable size. The size can vary depending upon the size of the sheets which are to be used. In one aspect, the support 14 has the dimensions of approximately 2¾″W×½″D×9″H.

This invention can be provided in other forms without departing from the spirit or essential attributes thereof. Accordingly, reference should be had to the following claims, rather than to the foregoing specification, as indicating the scope of the invention.

We claim:

1. An annotation apparatus for written material, comprising:
an elongated support; and
at least one annotation device secured to said support.

2. The annotation apparatus of claim 1, wherein at least one weight is secured to said support.

3. The annotation apparatus of claim 2, wherein at least two weights are secured to opposing ends of said support.

4. The annotation apparatus of claim 3, wherein said support has at least one side straight edge portion.

5. The annotation apparatus of claim 4, wherein said support is substantially rectangular.

6. The annotation apparatus of claim 1, wherein said elongated support has a substantially flat bottom portion.

7. The annotation apparatus of claim 1, wherein said annotation device is a writing implement and said support comprises structure for securing said writing implement.

8. The annotation apparatus of claim 7, wherein said structure for securing said at least one writing implement comprises a loop adapted to at least partially encircle and secure said writing implement.

9. The annotation apparatus of claim 1, wherein said annotation device comprises at least one removable place marker.

10. The annotation apparatus of claim 1, wherein said annotation device comprises stationery.

11. The annotation apparatus of claim 10, wherein said stationery is removable adhesive notes.

12. The annotation apparatus of claim 1, wherein said support is flexible.

13. The annotation apparatus of claim 1, wherein said support comprises leather.

14. The annotation apparatus of claim 1, wherein said annotation device is at least one selected from the group consisting of magnifiers and letter openers.

15. A method for annotating at least one sheet of written material, comprising the steps of:
providing an elongated support with at least one annotation device secured thereto;
placing said elongated support on at least one sheet of written material so as to hold said sheet in place; and
using said annotation device to annotate said written material.
